(19) United States
(12) Patent Application Publication
(10) Pub. No.: US 2022/0222521 A1
(43) Pub. Date: Jul. 14, 2022

(54) EFFICIENT WEIGHT UPDATES

(71) Applicant: Microsoft Technology Licensing, LLC, Redmond, WA (US)

(72) Inventors: Andy WAGNER, Cupertino, CA (US); Tiyasa MITRA, San Jose, CA (US)

(21) Appl. No.: 17/148,499

(22) Filed: Jan. 13, 2021

(51) Int. Cl. G06N 3/08; G06N 3/04; G06N 5/04

(52) U.S. Cl. CPC G06N 3/08; G06N 5/046; G06N 3/04

(57) ABSTRACT

Weights may be updated during training of a neural network artificial intelligence model. Certain techniques split the training data into mini-batches, process each mini-batch in a pipeline, and then apply the weight updates after processing of the mini-batch completes. However, waiting for the mini-batch to complete before applying the weight updates causes significant delays during a ramp-down period as the data must be flushed out of the pipeline and then again during a ramp-up period as the pipeline is being filled with data from the next mini-batch. The present disclosure avoids such delays and improves performance by applying the weight updates at specific intervals, without splitting the data into mini-batches. The updated weights may be applied during a steady-state operation of the pipeline.

### BACKGROUND

The present disclosure relates to computing, and more particularly to techniques for processing an artificial intelligence model such as an artificial neural network.

Artificial neural networks (hereinafter, neural network) have become increasingly important in artificial intelligence applications and modern computing in general. An example neural network is shown in FIG. 1. The neural network 100 receives input values corresponding to features to be recognized. The input values are multiplied by weights (represented by edges 101) and added together (e.g., summed) in nodes 102. An activation function is applied to the result in the nodes 102 to generate an output value. Values are combined across multiple nodes and layers of nodes to produce network output values corresponding to a result.

Such systems “learn” to perform tasks by considering examples, generally without being programmed with task-specific rules. Initially, the weights may be untrained. During a training phase, input values for corresponding known results are processed by the network, and a difference (or error) between the network output values and the known values is determined. The weights may be adjusted based on the error using a process known as backpropagation, where computations flow through the neural network in the reverse direction (e.g., from the output to the input). Training may involve successively adjusting weights across many input samples and corresponding known network output values. This is often referred to as the training phase. Once trained, the system may receive inputs and produce meaningful results (e.g., classification or recognition). This is often referred to as the inference phase.

FIG. 2 illustrates training of a neural network in a forward pass and a backward pass. In this example, four layers of a neural network are shown, including four forward operations (F0, F1, F2, F3) and four backward operations (B0, B1, B2, B3). Input data “A” is received as an input of the pipeline and is successively processed by each layer, forward and backward. A set of input data may be continuously received by the network to produce a stream of output results. One challenge with training certain neural networks is that networks with large numbers of layers require more memory. For instance, each layer may be required to store activations to be able to perform backpropagation.

Activation functions are mathematical equations that determine the output of a neural network. Activations sometimes refers to the values of the weights, for example, that produced a particular output at a particular time. Data may be flowing through the neural network continuously, and weights may be changing, and thus activations at particular times may be stored.

As shown in FIG. 2, the first forward operation (F0) 201 receives input “A” 202 and determines intermediate activations 203 (referred to as “activations” herein) based on the input 202, and provides an output activation 204 (referred to as “outputs” herein) to the second forward operation (F1). The output activation may be referred to as a tensor (T). The output activation may be used to determine an error (e.g., difference between the output activation and an expected result). The error may flow back through the layers for use in updating the weights during backpropogation.

The intermediate activations 203 calculated in the first forward operation (F0) may be used by the corresponding backward operation (B0) 205. The backward operations may include one or more operations performed using the forward operation with auto differentiation. Accordingly, the intermediate activations may be stashed (e.g., stored in a buffer) until the corresponding backward operation (B0) 205 is commenced, which may occur after all of the other intervening forward and backward operations are performed. However, stashing activations may require a significant amount of memory. Instead of stashing the intermediate activations, the input used to compute the intermediate activation may be stored instead and this input may be used to recompute the intermediate activation during the backward pass. The weight used during the forward pass may also be stored for use in such recomputations.

Neural networks consist of many numeric operations which need to be efficiently partitioned across computation resources. There are many approaches to partitioning the operations which are highly model and architecture specific. One partitioning approach that is especially suited to deep networks is to split layers onto sequential compute resources (e.g., separate devices or chips). Splitting layers is a hardware technique which for the case of neural networks leads directly to pipeline parallelism.

Pipeline parallelism is very efficient for feedforward networks but becomes much more complicated when feedback and weight updates are applied. One technique for neural networks is to update the weights based on a mini-batch of data elements (N example average). The approach is inefficient for a pipelined model as it requires the pipeline to flush out its contents before continuing. The flushing process clears the data out from the pipeline after the mini-batch has been processed. This means that the later stages in the pipeline are not processing data that they might otherwise be processing if the data were not split into mini-batches, causing delay in processing the entirety of the data. The delay caused by flushing leads to further delays as the pipeline must be refilled at the start of the next mini-batch. Refilling the pipeline requires the pipeline to be ramped-up as the first data element in the subsequent mini-batch is processed by the pipeline. Thus, processing data in mini-batches and updating weights after the mini-batch is processed may cause inefficiency and delay in training a neural network. In some implementations, such delays may account for 10-15% of time spent training a neural network. The amount of delay may be implementation specific.

One solution to avoid flushing the pipeline is to continuously update the weights each time that a weight is computed on the backward pass at each stage. Thus, the weights of the stages of the pipeline are updated asynchronously. However, the continuous update solution has a few issues in terms of performance and usability. Continuously updating the weights means that the weight gradient is not applied based on the weight used, and the weight used during re-computation of the activation in the backward pass uses a different or incorrect weight.

There is a need for improved techniques for processing neural networks in a pipeline.

### SUMMARY

Embodiments of the present provide improved techniques for processing neural networks in a pipeline.

One embodiment provides a computer system including one or more processors and a non-transitory computer readable storage medium coupled to the one or more processors. The storage medium having stored thereon program code executable by the one or more processors to train, using plurality of data samples, an artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The program code is further executable to apply updated weights to the plurality of stages at one or more predetermined intervals during a steady state operation of the training of the artificial intelligence model. The updated weights are applied such that a weight update calculation of the last stage has been performed based on a particular data sample and a weight update calculation of the first stage has not been performed based on the particular data sample.

Another embodiment provides a method of processing an artificial intelligence model. The method includes training, using plurality of data samples, the artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The method further includes applying updated weights to the plurality of stages at one or more predetermined intervals during a steady state operation of the training of the artificial intelligence model. The updated weights are applied such that a weight update calculation of the last stage has been performed based on a particular data sample and a weight update calculation of the first stage has not been performed based on the particular data sample.

Another embodiment provides a non-transitory computer readable storage medium having stored thereon program code executable by a computer system. The program code may cause the computer system to train, using plurality of data samples, an artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The program code may further cause the computer system to apply updated weights to the plurality of stages at one or more predetermined intervals during a steady state operation of the training of the artificial intelligence model. The weight updates are applied such that a weight update calculation of the last stage has been performed based on a particular data sample and a weight update calculation of the first stage has not been performed based on the particular data sample.

### BRIEF DESCRIPTION OF THE DRAWINGS

Various embodiments of the present disclosure are illustrated by way of example and not limitation in the figures of the accompanying drawings.

FIG. 1 illustrates a neural network.

FIG. 2 illustrates training of a neural network in a forward pass and a backward pass.

FIG. 3 illustrates a process for training a neural network, according to an embodiment.

FIG. 4 shows a table illustrating a pipeline training a neural network, according to an embodiment.

FIG. 5 shows a table illustrating delays, compared to the pipeline of FIG. 4, caused by flushing a pipeline when using mini-batches.

FIG. 6 illustrates training of a neural network using efficient weight updates based on stale data, according to an embodiment.

FIG. 7 illustrates training of a neural network using efficient weight updates not based on stale data, according to an embodiment.

FIG. 8 illustrates a simplified block diagram of an example computer system according to certain embodiments.

FIG. 9 illustrates a neural network processing system according to some embodiments.

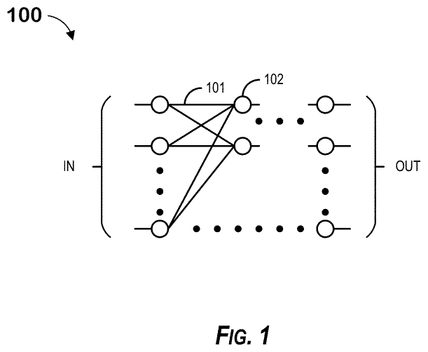

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

As discussed above, pipeline parallelism is very efficient for feedforward networks but becomes much more complicated when feedback and weight updates are applied. One technique for neural networks is to update the weights based on a mini-batch of data elements (N example average). The approach is inefficient for a pipelined model as it requires the pipeline to flush out its contents before continuing. The flushing operation requires the pipeline to be cleared out at the end of the mini-batch and refilled at the start of the next mini-batch leading to a large inefficiency.

To avoid the delay and reduced performance caused by flushing the pipeline in order to update the weights, the present disclosure provides a pipeline processing technique that synchronously applies the calculated weight updates to the stages of the pipeline at specific intervals without flushing the pipeline. The interval may be predetermined based on a particular number of operations being performed (e.g., after 64 or 1024, etc., backwards pass operations have been completed by a particular stage of the pipeline). The interval may be predetermined in a similar manner as selecting a mini-batch size even though the data will not be separated into mini-batches.

Since the pipeline is not flushed before the calculated weight updates are applied each interval, the different stages of the pipeline are operating on a different time schedule due to the nature of the pipeline. That is, different stages of the pipeline are currently operating on different data samples and may have completed operations on different sets of data samples when the weight update is applied. For example, the last stage in the pipeline may have completed backwards pass operations for a particular data sample when the weight updates are applied while a first stage in the pipeline may not have begun or completed its backwards pass operations for that particular data sample (e.g., because the intermediate stages in the pipeline will perform backwards pass operations on that data sample prior to the first stage doing so). Therefore, the total number of weight update calculations of the backwards pass operations that have been performed by the different stages of the pipeline may be different when the weight updates are applied to the stages.

Accordingly, the weight updates applied to the different stages may be based on different sets of data samples. If the weight updates are applied at an interval based on the last stage having completed a certain number of backwards pass operations (e.g., gradient calculations and weight update calculations), then the weight update at the last stage will be based on a data sample which is not used by the other stages at that moment in time. However, the weight update calculations for that data sample may be used by the other stages when the following weight update is applied after the next interval. As such, the previously existing weight calculations used in applying weight updates at a particular stage may correspond to forward pass operations that were performed during the previous interval. Thus, these weight update calculations may be referred to as “stale” weights).

Since the weight updates at certain stages may be applied before corresponding backwards pass operations have been performed, the weights used during the forwards pass operations may be stored for used in recomputation and in the backwards pass operations. Therefore, the old weight (e.g., prior to the update being applied) may be used for data that is still in the pipeline while the new updated weights are used with the input data in forwards pass operations after the interval. This technique allows full pipeline efficiency (e.g., each stage of the pipeline continuously performs operations as they are available for the entire set of training data) with only a single ramp-up period and a single ramp-down (e.g., flush) period needed to process all of the training data, compared to using mini-batches where each batch requires a ramp-up and a ramp-down period.

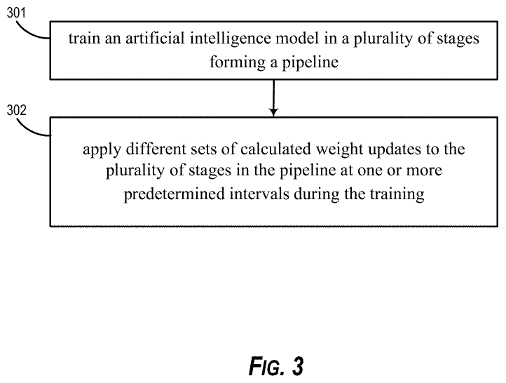

The technique of applying weight updates at specific intervals improves upon the continuous update technique described above. As mentioned above, the continuous update solution has a few issues in terms of performance and usability. Continuously updating the weights means that the weight gradient is not applied based on the weight used, and the weight used during re-computation of the activation in the backward pass uses the wrong weight. The technique of applying weight updates at specific intervals improves upon the continuous update technique because it uses a consistent weight gradient during all times except when flushing the pipeline after all data has been processed. A further improvement is that the activations are consistent because they are used with re-computation. The technique of updating weights at specific intervals trades memory for seeps as it requires an extra set of weight storage in order to ensure that the weight-based calculations are accurate. A process for implementing the technique of updating weights at specific intervals is described below with respect to FIG. 3.

FIG. 3 illustrates a process for training a neural network, according to an embodiment. At 301, the process trains, using plurality of data samples, the artificial intelligence model in a plurality of stages forming a pipeline. The training of the artificial intelligence model includes a forward pass calculation, a backward pass calculation, and a weight update calculation for each of the plurality of data samples at each stage of the pipeline.

At 302, the process applies different sets of calculated weight updates to the plurality of stages in the pipeline at one or more predetermined intervals during the training of the artificial intelligence model such that a fewer number of calculated weight updates are applied to one or more earlier stages of the pipeline and a greater number of calculated weight updates are applied to a later stage of the pipeline at each of the one or more predetermined intervals.

In some embodiments, the applying of the different sets of the calculated weight updates to the plurality of stages in the pipeline at a particular predetermined interval uses existing weights that have not been updated within a prior interval.

In some embodiments, the applying of the different sets of the calculated weight updates to the plurality of stages in the pipeline at a particular predetermined interval includes storing both the different sets of the calculated weight updates and one or more weights used in forward pass calculations during a prior interval.

In some embodiments, the plurality of data samples are not split into mini-batches to train the artificial intelligence model.

In some embodiments, the pipeline is in a steady-state operation during the applying of the different sets of the calculated weight updates to the plurality of stages, the pipeline not being flushed out prior to the applying of the different sets of the calculated weight updates to the plurality of stages.

In some embodiments, consistent weight gradients are used for a gradient calculation of the backward pass calculation, during steady state operation, for each of the plurality of data samples at each stage of the pipeline.

In some embodiments, the training of the artificial intelligence model in the plurality of stages forming the pipeline is completed while only flushing data from the pipeline once.

In some embodiments, the artificial intelligence model is an artificial neural network.

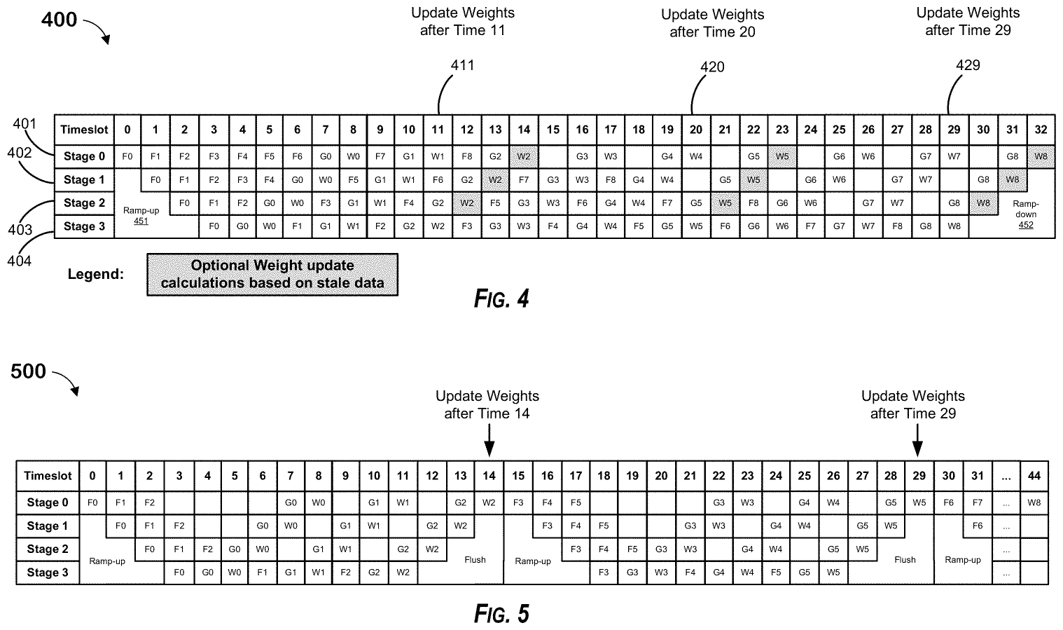

FIG. 4 shows a table 400 illustrating a pipeline training a neural network, according to an embodiment. In this example, the pipeline includes four stages (“stage 0” 401, “stage 1” 402, “stage 2” 403, and “stage 3” 404). That is, the neural network model is split across four devices (e.g., chips). In this example, there are 9 data elements to be used in training the neural network for simplicity of illustration. In other embodiments, billions of data samples may be used for training. In other embodiments, the weight update interval may also be much larger (e.g., 1024 data samples processed by a particular stage).

The pipeline stages 401-404 performs nine forward pass calculations (denoted as F0-F8 in FIG. 4), nine backward pass calculations which include corresponding gradient calculations (denoted as G0-G8 in FIG. 4) and weight update calculations (denoted as W0-W8 in FIG. 4), one for each data element. In some embodiments, the corresponding forward pass calculations may also be recomputed prior to performing the backward pass calculations. Each forward pass calculation, backward pass calculation, and weight update calculation fits into a particular timeslot (denoted as 0-32 in FIG. 4), as each of these three calculations may take approximately the same amount of time to be processed. The table 400 shows which calculations are being performed by each particular stage during the timeslots. Example equations for these calculations using a matrix are provided below.

The forwards pass calculation may be expressed as:

Y=W*ƒ(x)

Where Y is the calculated activation, W is the weight, and x is the input data being applied to an activation function ƒ.

The error calculation of the backwards pass may be expressed as:

Eₒᵤₜₚᵤₜ=transpose(W)*Eᵢₙₚᵤₜ

Where Eᵢₙₚᵤₜ is the error output from the prior stage in the backwards pass (e.g., the stage that was the next stage in the corresponding forwards pass), which is multiplied by the of the weight W to calculate the error Eₒᵤₜₚᵤₜ to output to the subsequent stage in the backwards pass.

The weight update calculation may be expressed as:

Wₙ=Wₙ₋₁+u*E×x

Where Wₙ is the updated weight, Wₙ₋₁ is the previously used weight, and u is a gain term, which is multiplied by the error E cross the data x. Thus, the weight that was used in the forwards pass calculation is also used in the weight update calculation.

As data is processed in the pipeline, each of the four stages 401-404 (stage 0-3) may perform processing in parallel with the other stages in a pipeline as shown in FIG. 4. For instance, after the first stage 401 (stage 0) performs a first forward operation (F0) for the first data element at timeslot 0, the first stage 401 (stage 0) may perform a first forward operation (F1) for the second data element at timeslot 1 while the second stage 402 (stage 1) performs a second forward operations for the first data element at timeslot 1. As shown in FIG. 4, there is a ramp-up period 451 (timeslot 0-2) where later stages in the pipeline are idle during processing of the initial data elements by the earlier stages.

Once the pipeline has ramped up 451, it operates in a steady state (timeslot 3-29) until the last stage in the pipeline has performed the backwards pass calculations for the last data sample in the training set. “Steady state operation” may refer to a pipeline state in which each stage of the pipeline will perform calculations as they become available (i.e., the stages do not delay processing in order to flush data out of the pipeline). During “steady state operation” there may be periods in which a particular stage is idle after forward pass calculations for all data samples of the training data have processed, but before the corresponding backwards pass calculations have been provided by the subsequent stage in the pipeline. For instance, the first stage 401 (stage 0) may be idle at timeslots 15, 18, 21, 24, 27, and 30, the second stage 402 (stage 1) may be idle at timeslots 20, 23, 26, and 29, and the third stage 403 (stage 2) may be idle at timeslots 25 and 28. The fourth stage 404 (stage 3), which is the final stage in the pipeline, may not be idle until at ramp-down period 452 begins at timeslot 30 and continues to timeslot 32 when the last weight update calculation (for the 8^{th} data element) is complete, at which point all of the data will have been flushed out of the pipeline. As an example, Stage 0 is idle at timeslot 15 after having processed F8 since it is waiting for Stage 1 to finish processing G3 at timeslot 15.

As shown in FIG. 4, the training of the neural network has been performed while only flushing the data out of the pipeline a single time during the tamp down period 452. However, the training does not wait to apply the weight update calculations until after the pipeline has been flushed. Instead, the weight update calculations are applied to each of the stages at certain intervals. In this example, the weight update calculations are applied after the final stage of the pipeline (stage 3) has performed the backward pass calculation and weight update calculation for 3 data elements. Thus, weight updates are applied after calculating the weight update at timeslots 11, 20, and 29.

Looking at timeslot 0-11, the fourth stage 404 (stage 3) has calculated the first three weight updates W0, W1, and W2 (for the first, second, and third data elements) while the first, second and third stages 401, 402, 403 (stages 0-2) have only calculated two weight updates W0 and W1, and have not yet calculated the third weight update W2. The third stage 403 (stage 2) will calculate W2 at timeslot 12, while the second stage 402 (stage 1) calculates W2 at timeslot 13. The first stage 401 (stage 0) will not calculate W2 until timeslot 14. Accordingly, if the weight updates are applied after the processing at timeslot 11 (411), then the updated weight stored the first stage (Stage 0) and at the last stage (Stage 3) may be based on different data samples as follows:

Weight_{Stage0}[time 11]=W0+W1

Weight_{Stage3}[time 11]=W0+W1+W2

That is, the weight update applied to the last stage at “timeslot 11” (411) is based on W0, W1, and W2 while the weight update applied to the first stage at timeslot 11 is based on W0 and W1, but not W2 because the first stage has not yet processed W2 at timeslot 11 (411). However, the weight update W2 processed by the first stage may be used in later weight updates even if it is “stale” (e.g., it is based on data that was processed in forwards pass operations during the previous interval). That is, the weight updates applied after the processing at timeslot 20 (420) for certain stages may be based on different data samples as follows:

Weight_{Stage0}[time 20]=W2+W3+W4

Weight_{Stage3}[time 20]=W3+W4+W5

Thus, the last stage (Stage 3) uses W2 when applying the weight update at timeslot 11 while the other stages use W2 in the following weight update occurring after the interval. In FIG. 4, the W2 processing by Stage 2, Stage 1, and Stage 0 at timeslots 12, 13, and 14 respectively is highlighted gray to indicate that the calculations are based on “stale” data. In such embodiments, additional weights may need to be stored at by stages using stale data since they may perform forward pass calculations using the new weight that was applied and they may perform backward pass calculations using the previous weight that was used before the weight update was applied.

In some embodiments, the training of the neural network may skip processing of weight update calculations by stages that would process it after the weight update has been applied (e.g., the processing highlighted in gray in FIG. 4). Thus, such operations are optional. In such embodiments, the stages of the pipeline may not need to store additional weights since the weight update calculations that would be performed after the update are not performed.

Given that the weight update has been applied at timeslot 11 (411), the new weights may be used in calculating the forward pass and the backward pass for new input data. For instance, the forward pass for the 9^{th} data element (F8) at timeslot 12 will use the newly applied weights. In this example, only 9 data elements are being processed for simplicity of explanation and drawing. However, in a real implementation it is likely that more data elements will be processed. In such cases each new input will be processed using the newly applied weights. As such, a fewer number of calculated weight updates (2 weight updates W0 and W1 in this example) are applied to one or more earlier stages of the pipeline (401-403, in this example) and a greater number of calculated weight updates (3 weight updates: W0, W1, and W2 in this example) are applied to a later stage of the pipeline (i.e., the fourth stage 404) at each of the one or more predetermined intervals. Because of this, the weight update calculations (W2) for the third data element are not based on all of the data when calculated by the third stage 403 (stage 2) at timeslot 12, by the second stage 402 (stage 1) at timeslot 13, and by the first stage 401 (stage 0) at timeslot 14. This fact is denoted by gray highlighting in FIG. 4.

The weight update calculation (W2) by the third stage 403 (stage 2) at timeslot 12, by the second stage 402 (stage 1) at timeslot 13, and by the first stage 401 (stage 0) at timeslot 14 may not be based on all of the data because it may be performed with “stale” data (e.g., weight data that was used in training the neural network before the weights were updated at timeslot 11) or it may not be updated. In the case where stale data is used, the training of the neural network may involve storing both the calculated weight updates and the stale data.

As shown in FIG. 4, the weight update calculations W4 performed by stage 0 (401), stage 1 (402), and stage 2 (403) (at timeslots 21, 22, and 23 respectively) and the weight update calculation W8 performed by those stages (at timeslots 30, 31, and 32 respectively) may be based on stale data or they may not be performed. As such, data may be left out of the weight update calculations. However, in many implementations there will much more than 3 data samples being processed by a particular within an interval. For example, if 1024 data samples are processed by the last stage within an interval, then the amount of data left out of the weight update calculations at the earlier stages may be minimal (e.g., a few calculations out of 1024 depending on the particular stage).

Thus the loss of data used when synchronously updating the weights at the specific intervals may be insignificant compared to the significant delays in the alternative mini-batch solution which are caused by waiting for the data to be flushed out of the pipeline. That is, waiting for the data to be flushed out of the pipeline (e.g., when processing data in mini-batches) before applied the weight updates ensures that all of the data is used when applying the weight updates, but loss of a few data samples may not have a significant change on the resulting weight update when a large number of data samples are being processed (e.g., 64, 512, 1024, etc.).

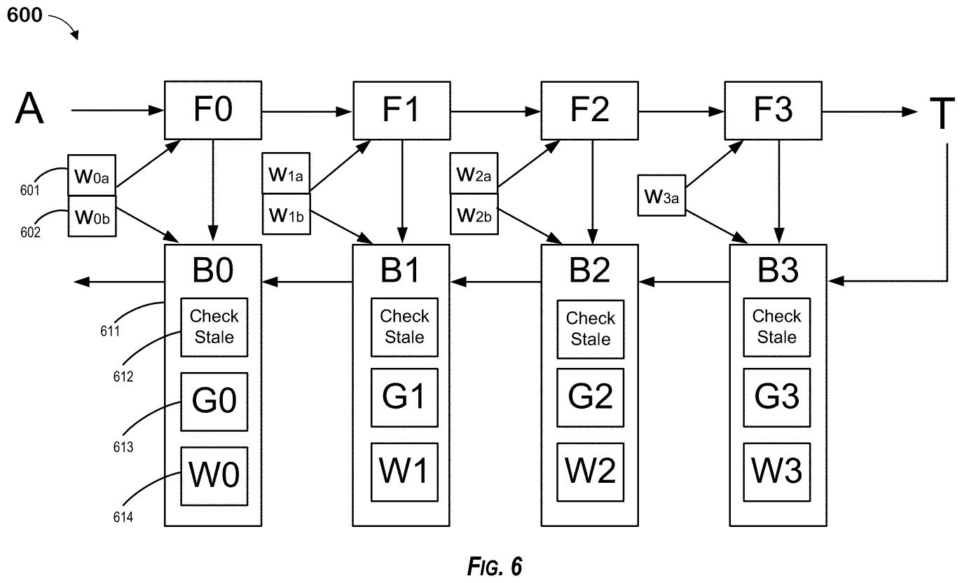

FIG. 5 shows a table 500 illustrating delays, compared to the pipeline of FIG. 4, caused by flushing a pipeline when using mini-batches. The pipeline in FIG. 5 processes a neural network using 4 stages (stage 0-3) with a mini-batch size of 3 data elements. A mini-batch size of 3 is used in this example for simplicity of explanation and depiction, and for comparison to the processing in FIG. 4 using an interval of 3. While a small mini-batch size of 3 is used in this example, other sizes of mini-batches (e.g., 64, 128, 256, or any other number) still exhibit the same delays caused by flushing the pipeline prior to applying the weight update.

As shown in FIG. 5, the all of the data for a mini-batch is flushed out of the pipeline before weight updates are applied based on that mini-batch. For instance, the processing of the first three data elements completes at timeslot 14, after which the data may be flushed out of the pipeline and the weight updates may be applied. However, this causes a second ramp-up period where one or more of stages 1-3 are idle during timeslots 15-17, on top of these stages being idle at one or more of time slots 12-14 during the flushing of the pipeline. In this example, there are 12 timeslots where a stage could have been processing data but is instead idle due to waiting for the mini-batch to process until applying the weight updates.

This delay is significant compared to the processing shown in FIG. 4 where weight updates are applied at intervals without flushing the pipeline. For instance, a 4 stage pipeline can complete training of a neural network using 9 data elements over 32 time slots (as shown in FIG. 4) without flushing the data, while a 4 stage pipeline can only complete processing of 6 data elements (2 mini-batches) in 29 time slots, with 44 time slots being needed to complete training using 9 data elements. The amount of delay caused depends on the number of stages and the size of the mini-batch.

Features and advantages of applying weight updates at specific intervals during training of an artificial intelligence model (e.g., neural network) include avoiding the delay and reduced performance caused by flushing the pipeline when the data is split into mini-batches in order to update the weights. This technique allows full pipeline efficiency with only a single ramp-up period and a single ramp-down (e.g., flush) period needed to process all of the data, compared to using mini-batches where each batch requires a ramp-up and a ramp-down period. Furthermore, this technique of applying weight updates at specific intervals improves upon the continuous update technique, as described above.

As discussed above, an updated weight based on a set of weight update calculations may be applied to a particular stage such that the updated weight may be used in later forward pass calculations. However, when implementing the efficient weight updates during steady state operation as discussed above with respect to FIG. 4, different stages may have completed weight updates on different sets of data since the calculations are offset in time across the pipeline. Certain weight calculations (e.g., W2 in timeslot 12, W2 in timeslot 13, and W2 in timeslot 14 highlighted in gray in FIG. 4) may be based on stale data (e.g., data that was processed in a forward pass prior to the current updated weight being applied to a particular stage).

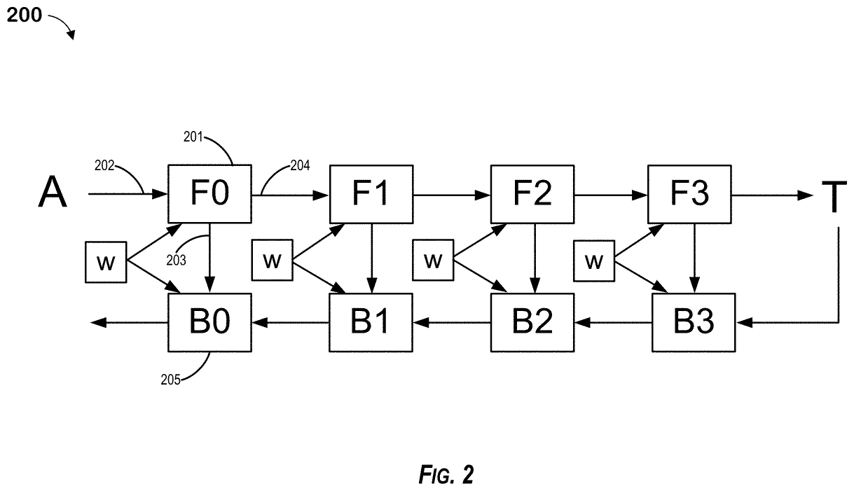

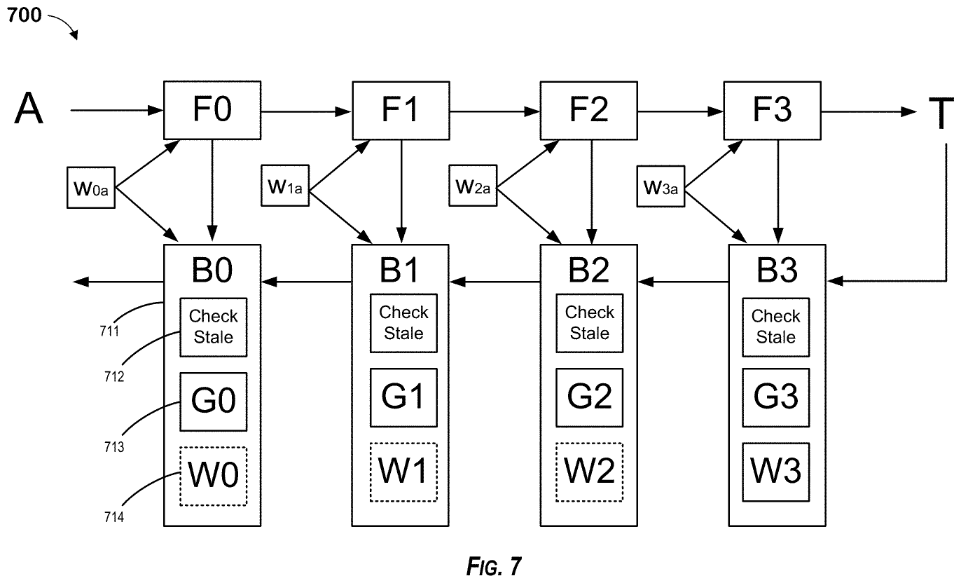

FIG. 6 illustrates training 600 of a neural network using efficient weight updates based on stale data, according to an embodiment. The training of the neural network may be performed similar to the training discussed above with respect to FIGS. 2-4. In this embodiment, each stage of the four stage pipeline except for the last stage stores two weights to use in calculations. The last stage may not store two weights because it may perform a backwards pass after the corresponding forwards pass without interruption. In this embodiment, the first stage (e.g., Stage 0) stores a first weight (W₀ₐ) 601 for use in forwards pass calculations (F0) and a second weight (W_{0b}) 602 for use in backwards pass operations. The applying of the weight update discussed herein may store a new weight value for the first weight (W₀ₐ) 601 to be used in new forward pass operations occurring after an interval has passed. However, since the old weight before the applying of the weight update was used in forward pass calculations for data samples that are still being processed in the pipeline, the old weight is stored as the second weight (W_{0b}) 602.

The first stage (Stage 0) may include backwards pass operations (B0) 611 including a gradient calculation (G0) 613, a weight update calculation (W0) 614, and a staleness checking operation 612 (“check stale” in FIG. 6). The staleness check operation may determine whether the current data being processed by the stage in the backwards pass is based on stale data. That is, the current backwards pass operation is based on a data sample that was processed in a forwards pass operation during the previous interval prior to the most recent application of the weight update to the stage. If the staleness operation determined that the current operations are based on stale data then the second weight (W_{0b}) 602 is used for the operations since that weight was used during the corresponding forward pass operations based on that data sample. Thus, there is consistency in the weights used, providing consistent between the forwards pass and backwards pass operations. The second stage (including F1 and B1) and third stage (including F2 and B2) are configured similar to the first stage (including F0 and B0).

An example of applying weight updates based on stale data was given above with respect to FIG. 4 where the weight updates applied after the processing at timeslot 20 (420) for the first stage (stage 0) was based on different data samples compared to the last stage (stage 3):

Weight_{Stage0}[time 20]=W2+W3+W4

Weight_{Stage3}[time 20]=W3+W4+W5

In this example, the weight calculation W2 of the first stage (stage 0) is based on stale data because the forwards pass calculation (F2) corresponding to the weight calculation (W2) was performed in timeslot 2 during the first interval (e.g., timeslots 0-11) while the weight calculation (W2) was performed by Stage 0 in timeslot 14, after the weight updates were applied at timeslot 11.

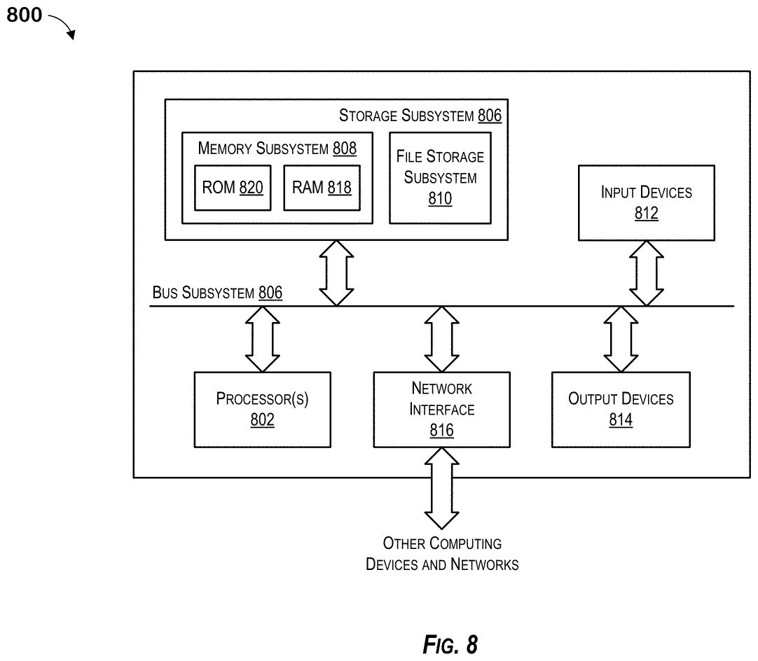

As discussed above, the weight calculations may be based on stale data. However, in some embodiments the weight calculations may not be based on stale data. In some embodiments, such weight calculations based on stale data may not be performed. FIG. 7 illustrates training 700 of a neural network using efficient weight updates not based on stale data, according to an embodiment. The training of the neural network may be performed similar to the training discussed above with respect to FIGS. 2-4. In this embodiment, each stage of the pipeline except for the last stage may optionally perform weight update calculations. The weight update calculations may not be performed if the data is stale. The last stage may not process stale data since it may perform backwards pass operations after the corresponding forwards pass operations without interruption.

In this embodiment, the first stage (e.g., Stage 0) stores a first weight (W₀ₐ) 701 for use in forwards pass calculations (F0) and in backwards pass operations. Unlike the embodiment discussed above with respect to FIG. 6, a second weight (W_{0b}) is not stored for use in backwards pass operations because weight update calculations may not be performed if the data is stale. In FIG. 7, the weight update calculations W0, W1, and W2 are illustrated with dotted lines to indicate that such operations are optional (e.g., they performed when the data is not stale, and they may not be performed when the data is stale). As such, a second weight is not needed to ensure consistency.

The first stage of the pipeline may include backwards pass operations (B0) 711 including a gradient calculation (G0) 713, a weight update calculation (W0) 714, and a staleness checking operation 712 (“check stale” in FIG. 7). The staleness check operation may determine whether the current data being processed by the stage in the backwards pass is based on stale data. That is, the current backwards pass operation is based on a data sample that was processed in a forwards pass operation during the previous interval prior to the most recent application of the weight update to the stage. If the staleness operation 712 determined that the current operations are based on stale data the weight update calculation 714 is not performed based on the stale data. The second stage (including F1 and B1) and third stage (including F2 and B2) are configured similar to the first stage (including F0 and B0).

In the example of the other embodiment discussed above with respect to FIG. 6, the weight updated applied to the first stage at timeslot 20 may be based on W2, which is based on stale data:

Weight_{Stage0}[time 20]=W2+W3+W4

Weight_{Stage3}[time 20]=W3+W4+W5

However, in this embodiments, the weight calculation W2 may not be performed if the staleness checking operation 711 determines that it would be based on stale data. Accordingly, the weight update applied to the first stage at timeslot 20 may not be based on W2 since it is based on stale data:

Weight_{Stage0}[time 20]=W3+W4

Weight_{Stage3}[time 20]=W3+W4+W5

Not performing the weight update calculation for stale data is advantageous because additional weights (e.g., W_{0b}, W_{1b}, W_{2b}, W_{3b} in FIG. 6) do not need to be stored in order to ensure consistency with the previously performed forwards pass operations. Consistency is not needed because the weight update calculation is not performed. While FIG. 4 is simplified to show training using nine data samples with weight updates being applied after three data samples are processed by the last stage, other implementations will include more data samples (e.g., billions) and the interval for applying weight updates will also be larger (e.g., 1024 data samples processed). In embodiments where the interval is large, the percentage of weight update calculations that are not performed due to stale data may be small. Any small loss in accuracy this causes may be offset by the large gains in processing efficiency provided by performed efficiency weight updates during steady state operations, without flushing data from the pipeline, as discussed here.

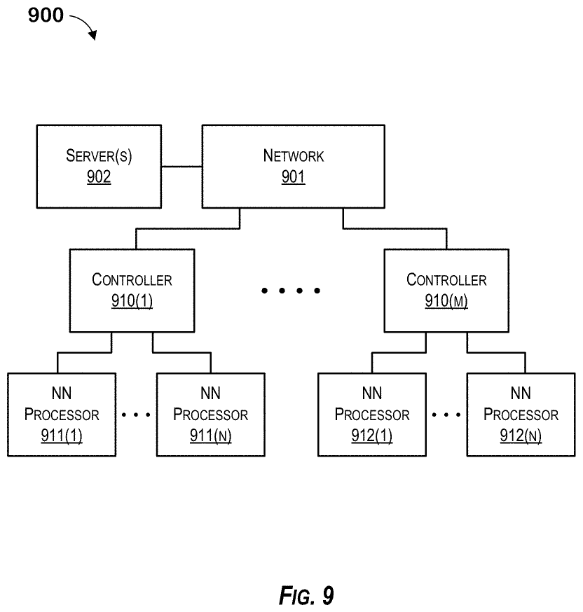

FIG. 8 depicts a simplified block diagram of an example computer system 800, which can be used to implement the techniques described in the foregoing disclosure. As shown in FIG. 8, computer system 800 includes one or more processors 802 that communicate with a number of peripheral devices via a bus subsystem 804. These peripheral devices may include a storage subsystem 806 (e.g., comprising a memory subsystem 808 and a file storage subsystem 810) and a network interface subsystem 816. Some computer systems may further include user interface input devices 812 and/or user interface output devices 814.

Bus subsystem 804 can provide a mechanism for letting the various components and subsystems of computer system 800 communicate with each other as intended. Although bus subsystem 804 is shown schematically as a single bus, alternative embodiments of the bus subsystem can utilize multiple busses.

Network interface subsystem 816 can serve as an interface for communicating data between computer system 800 and other computer systems or networks. Embodiments of network interface subsystem 816 can include, e.g., Ethernet, a Wi-Fi and/or cellular adapter, a modem (telephone, satellite, cable, ISDN, etc.), digital subscriber line (DSL) units, and/or the like.

Storage subsystem 806 includes a memory subsystem 808 and a file/disk storage subsystem 810. Subsystems 808 and 810 as well as other memories described herein are examples of non-transitory computer-readable storage media that can store executable program code and/or data that provide the functionality of embodiments of the present disclosure.

Memory subsystem 808 includes a number of memories including a main random access memory (RAM) 818 for storage of instructions and data during program execution and a read-only memory (ROM) 820 in which fixed instructions are stored. File storage subsystem 810 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

FIG. 9 illustrates a neural network processing system according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia Corp®), field programmable gate arrays (FPGA) (e.g., FPGAs for processing neural networks produced by Xilinx®), or a variety of application specific integrated circuits (ASICs) or neural network processors comprising hardware architectures optimized for neural network computations, for example.

In this example environment, one or more servers 902, which may comprise architectures illustrated in FIG. 8 above, may be coupled to a plurality of controllers 910(1)-910(M) over a communication network 901 (e.g., switches, routers, etc.). Controllers 910(1)-910(M) may also comprise architectures illustrated in FIG. 8 above. Each controller 910(1)-910(M) may be coupled to one or more NN processors, such as processors 911(1)-911(N) and 912(1)-912(N), for example. NN processors 911(1)-711(N) and 712(1)-712(N) may include a variety of configurations of functional processing blocks and memory optimized for neural network processing, such as training or inference. The NN processors are optimized for neural network computations. Server 902 may configure controllers 910 with NN models as well as input data to the models, which may be loaded and executed by NN processors 911(1)-911(N) and 912(1)-912(N) in parallel, for example. Models may include layers and associated weights as described above, for example. NN processors may load the models and apply the inputs to produce output results. NN processors may also implement training algorithms described herein, for example.

### Further Example Embodiments

In various embodiments, the present disclosure includes systems, methods, and apparatuses for neural network training.

One embodiment provides a computer system including one or more processors and a non-transitory computer readable storage medium coupled to the one or more processors. The storage medium having stored thereon program code executable by the one or more processors to train, using plurality of data samples, an artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The program code is further executable to apply updated weights to the plurality of stages at one or more predetermined intervals during a steady state operation of the training of the artificial intelligence model. The updated weights are applied such that a weight update calculation of the last stage has been performed based on a particular data sample and a weight update calculation of the first stage has not been performed based on the particular data sample.

Another embodiment provides a method of processing an artificial intelligence model. The method includes training, using plurality of data samples, the artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The method further includes applying updated weights to the plurality of stages at one or more predetermined intervals during a steady state operation of the training of the artificial intelligence model. The updated weights are applied such that a weight update calculation of the last stage has been performed based on a particular data sample and a weight update calculation of the first stage has not been performed based on the particular data sample.

Another embodiment provides a non-transitory computer readable storage medium having stored thereon program code executable by a computer system. The program code may cause the computer system to train, using plurality of data samples, an artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The program code may further cause the computer system to apply updated weights to the plurality of stages at one or more predetermined intervals during a steady state operation of the training of the artificial intelligence model. The weight updates are applied such that a weight update calculation of the last stage has been performed based on a particular data sample and a weight update calculation of the first stage has not been performed based on the particular data sample.

One embodiment provides a computer system including one or more processors and a non-transitory computer readable storage medium coupled to the one or more processors. The storage medium having stored thereon program code executable by the one or more processors to train, using plurality of data samples, an artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The program code is further executable to apply updated weights to the plurality of stages at one or more predetermined intervals during a steady state operation of the training of the artificial intelligence model. The updated weights are applied such that a weight update calculation of the last stage has been performed based on a particular data sample and a weight update calculation of the first stage has not been performed based on the particular data sample.

In some embodiments of the computer system, an updated weight applied to the last stage is based on the particular data sample and an updated weight applied to the first stage is not based on the particular data sample.

In some embodiments of the computer system, a second interval occurs after a first interval, and an updated weight applied to the first stage at a second interval is based on a first data sample used in a forward pass calculation during the first interval.

In some embodiments of the computer system, wherein the weight update calculation of the first stage is not performed based on the particular data sample during the training of the artificial intelligence model

In some embodiments of the computer system, the program code executable by the one or more processors to store, at the first stage, the updated weight and a previous weight used in calculating the updated weight.

In some embodiments of the computer system, the pipeline is not flushed out prior to the applying of the updated weights to the plurality of stages.

In some embodiments of the computer system, each backward pass calculation at a particular stage of the pipeline is based on a same weight as a corresponding forward pass calculation when the corresponding forward pass calculation is performed before an updated weight is applied to the particular stage and the backward pass calculation is performed after the updated weight is applied to the particular stage.

In some embodiments of the computer system, the training of the artificial intelligence model is completed while only flushing data from the pipeline once.

In some embodiments of the computer system, the artificial intelligence model is an artificial neural network.

Another embodiment provides a method of processing an artificial intelligence model. The method includes training, using plurality of data samples, the artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The method further includes applying updated weights to the plurality of stages at one or more predetermined intervals during a steady state operation of the training of the artificial intelligence model. The updated weights are applied such that a weight update calculation of the last stage has been performed based on a particular data sample and a weight update calculation of the first stage has not been performed based on the particular data sample.

In some embodiments of the method, an updated weight applied to the last stage is based on the particular data sample and an updated weight applied to the first stage is not based on the particular data sample.

In some embodiments of the method, a second interval occurs after a first interval, and an updated weight applied to the first stage at a second interval is based on a first data sample used in a forward pass calculation during the first interval.

In some embodiments of the method, wherein the weight update calculation of the first stage is not performed based on the particular data sample during the training of the artificial intelligence model

In some embodiments of the method, the program code executable by the one or more processors to store, at the first stage, the updated weight and a previous weight used in calculating the updated weight.

In some embodiments of the method, the pipeline is not flushed out prior to the applying of the updated weights to the plurality of stages.

In some embodiments of the method, each backward pass calculation at a particular stage of the pipeline is based on a same weight as a corresponding forward pass calculation when the corresponding forward pass calculation is performed before an updated weight is applied to the particular stage and the backward pass calculation is performed after the updated weight is applied to the particular stage.

In some embodiments of the method, the training of the artificial intelligence model is completed while only flushing data from the pipeline once.

In some embodiments of the method, the artificial intelligence model is an artificial neural network.

Another embodiment provides a non-transitory computer readable storage medium having stored thereon program code executable by a computer system. The program code may cause the computer system to train, using plurality of data samples, an artificial intelligence model in a plurality of stages forming a pipeline. The pipeline includes a first stage and a last stage. Each of the plurality of stages of the pipeline performs a forward pass calculation based on a particular weight, a backward pass calculation based on the particular weight, and a weight update calculation based on the particular weight for each of the plurality of data samples. The program code may further cause the computer system to apply updated weights to the plurality of stages at one or more predetermined intervals during a steady state operation of the training of the artificial intelligence model. The weight updates are applied such that a weight update calculation of the last stage has been performed based on a particular data sample and a weight update calculation of the first stage has not been performed based on the particular data sample.

In some embodiments of the storage medium, an updated weight applied to the last stage is based on the particular data sample and an updated weight applied to the first stage is not based on the particular data sample.

In some embodiments of the storage medium, a second interval occurs after a first interval, and an updated weight applied to the first stage at a second interval is based on a first data sample used in a forward pass calculation during the first interval.

In some embodiments of the storage medium, wherein the weight update calculation of the first stage is not performed based on the particular data sample during the training of the artificial intelligence model

In some embodiments of the storage medium, the program code executable by the one or more processors to store, at the first stage, the updated weight and a previous weight used in calculating the updated weight.

In some embodiments of the storage medium, the pipeline is not flushed out prior to the applying of the updated weights to the plurality of stages.

In some embodiments of the storage medium, each backward pass calculation at a particular stage of the pipeline is based on a same weight as a corresponding forward pass calculation when the corresponding forward pass calculation is performed before an updated weight is applied to the particular stage and the backward pass calculation is performed after the updated weight is applied to the particular stage.

In some embodiments of the storage medium, the training of the artificial intelligence model is completed while only flushing data from the pipeline once.

In some embodiments of the storage medium, the artificial intelligence model is an artificial neural network.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A computer system comprising:
one or more processors; and
a non-transitory computer readable storage medium coupled to the one or more processors and having stored thereon program code executable by the one or more processors to:
train, using plurality of data samples, an artificial intelligence model in a plurality of stages forming a pipeline, the pipeline including a first stage and a last stage, each of the plurality of stages of the pipeline performing a forward pass calculation based on a particular weight, a backward pass calculation based on the particular weight, and a weight update calculation based on the particular weight for each of the plurality of data samples; and
apply updated weights to the plurality of stages at one or more predetermined intervals during a steady state operation of the training of the artificial intelligence model such that a weight update calculation of the last stage has been performed based on a particular data sample and a weight update calculation of the first stage has not been performed based on the particular data sample.

2. The computer system of claim 1, wherein an updated weight applied to the last stage is based on the particular data sample, and an updated weight applied to the first stage is not based on the particular data sample.

3. The computer system of claim 1, wherein a second interval occurs after a first interval, and an updated weight applied to the first stage at a second interval is based on a first data sample used in a forward pass calculation during the first interval.

4. The computer system of claim 1, wherein the weight update calculation of the first stage is not performed based on the particular data sample during the training of the artificial intelligence model.

5. The computer system of claim 1, wherein the program code executable by the one or more processors to store, at the first stage, the updated weight and a previous weight used in calculating the updated weight.

6. The computer system of claim 1, wherein the pipeline is not flushed out prior to the applying of the updated weights to the plurality of stages.

7. The computer system of claim 1, wherein each backward pass calculation at a particular stage of the pipeline is based on a same weight as a corresponding forward pass calculation when the corresponding forward pass calculation is performed before an updated weight is applied to the particular stage and the backward pass calculation is performed after the updated weight is applied to the particular stage.

8. The computer system of claim 1, wherein the training of the artificial intelligence model is completed while only flushing data from the pipeline once.

9. The computer system of claim 1, wherein the artificial intelligence model is an artificial neural network.

10. A method of processing an artificial intelligence model comprising:
training, using plurality of data samples, the artificial intelligence model in a plurality of stages forming a pipeline, the pipeline including a first stage and a last stage, each of the plurality of stages of the pipeline performing a forward pass calculation based on a particular weight, a backward pass calculation based on the particular weight, and a weight update calculation based on the particular weight for each of the plurality of data samples; and
applying updated weights to the plurality of stages at one or more predetermined intervals during a steady state operation of the training of the artificial intelligence model such that a weight update calculation of the last stage has been performed based on a particular data sample and a weight update calculation of the first stage has not been performed based on the particular data sample.

11. The method of claim 10, wherein an updated weight applied to the last stage is based on the particular data sample, and an updated weight applied to the first stage is not based on the particular data sample.

12. The method of claim 10, wherein the applying of the different sets of the calculated weight updates to the plurality of stages in the pipeline at a particular predetermined interval includes storing both the different sets of the calculated weight updates and one or more weights used in forward pass calculations during a prior interval.

13. The method of claim 10, wherein a second interval occurs after a first interval, and an updated weight applied to the first stage at a second interval is based on a first data sample used in a forward pass calculation during the first interval.

14. The method of claim 10, wherein the weight update calculation of the first stage is not performed based on the particular data sample during the training of the artificial intelligence model.

15. The method of claim 10, further comprising storing, at the first stage, the updated weight and a previous weight used in calculating the updated weight.

16. The method of claim 10, wherein the pipeline is not flushed out prior to the applying of the updated weights to the plurality of stages.

17. The method of claim 10, wherein each backward pass calculation at a particular stage of the pipeline is based on a same weight as a corresponding forward pass calculation when the corresponding forward pass calculation is performed before an updated weight is applied to the particular stage and the backward pass calculation is performed after the updated weight is applied to the particular stage.

18. A non-transitory computer readable storage medium having stored thereon program code executable by a computer system, the program code causing the computer system to:
train, using plurality of data samples, an artificial intelligence model in a plurality of stages forming a pipeline, the pipeline including a first stage and a last stage, each of the plurality of stages of the pipeline performing a forward pass calculation based on a particular weight, a backward pass calculation based on the particular weight, and a weight update calculation based on the particular weight for each of the plurality of data samples; and
apply updated weights to the plurality of stages at one or more predetermined intervals during a steady state operation of the training of the artificial intelligence model such that a weight update calculation of the last stage has been performed based on a particular data sample and a weight update calculation of the first stage has not been performed based on the particular data sample.

19. The non-transitory computer readable storage medium of claim 18, wherein a second interval occurs after a first interval, and an updated weight applied to the first stage at a second interval is based on a first data sample used in a forward pass calculation during the first interval.

20. The non-transitory computer readable storage medium of claim 18, wherein the weight update calculation of the first stage is not performed based on the particular data sample during the training of the artificial intelligence model.
